(19) United States
(12) Patent Application Publication
(10) Pub. No.: US 2022/0115725 A1
(43) Pub. Date: Apr. 14, 2022

(54) Horizontal Lead Storage Battery

(71) Applicant: TIANNENG BATTERY GROUP CO., LTD., Huzhou (CN)

(72) Inventors: Zhuo LIU, Huzhou (CN); Guanrui YUAN, Huzhou (CN); Qingshan TIAN, Huzhou (CN); Xingyu CAO, Huzhou (CN); Chao WANG, Huzhou (CN); Keyu LIU, Huzhou (CN); Jingyuan FAN, Huzhou (CN); Wenwei ZHOU, Huzhou (CN); Xufeng TANG, Huzhou (CN); Qiushi YAO, Huzhou (CN); Dan LI, Huzhou (CN); Lu SHI, Huzhou (CN)

(21) Appl. No.: 17/645,304

(22) Filed: Dec. 20, 2021

Related U.S. Application Data
(63) Continuation of application No. PCT/CN2019/105496, filed on Sep. 12, 2019.

(30) Foreign Application Priority Data
Jun. 18, 2019 (CN) 201910527678.8

(51) Int. Cl. H01M 50/186; H01M 10/14; H01M 50/531

(52) U.S. Cl. CPC H01M 50/186; H01M 50/531; H01M 10/14

(57) ABSTRACT

The invention discloses a horizontal lead storage battery include a battery container and a cover; the interior of said battery container is installed with a partition that divides its inner cavity into a plurality of single cells, and each cell is installed with a plate group; the adjacent plate groups are connected by a bridge; said partition has a gap for the bridge to pass through, and a sealing component is installed at the gap; said sealing component comprises two sealing plates with a gap and sealed with said partition; said gap is filled with sealant. The gap of the partition of present invention is provided with two sealing plates, the gap between the two sealing plates is filled with sealant, and the tiny gap between the sealing plate and the partition is sealed by sealing, thereby improving the sealing effect.

### CROSS-REFERENCE TO RELATED APPLICATIONS

This application is a continuation of International Patent Application Number PCT/CN2019/105496, filed on Sep. 12, 2019, which claims the benefit and priority of Chinese Patent Application Number 201910527678.8, filed on Jun. 18 2019 with China National Intellectual Property Administration, the disclosures of which are incorporated herein by reference in their entireties.

### TECHNICAL FIELD

The present invention relates to a lead storage battery, in particular to a lead storage battery with horizontally arranged polar plates.

### BACKGROUND ART

The traditional lead storage battery is composed of a plurality of plate groups connected in series, each plate group is composed of positive and negative plates arranged at intervals and partitions arranged between adjacent plates, the plates of the same group are connected through bus bars, and adjacent plate groups are connected by bridges. Most of the existing batteries are installed vertically. Due to problems such as electrolyte stratification, the plate reaction is uneven, the pressure drop and current density of plate surface are uneven, the internal resistance is high, the high current high power discharge performance is poor, and product life is short. In addition, during the manufacturing process of traditional batteries, there are problems such as pollution of lead parts inside the battery, pollution of cross-bridge welding, pollution of lug cast welding of plate group, high equipment investment, high energy consumption and high manpower consumption.

To solve such problem, CN205846157U discloses a lead-acid horizontal battery, which comprises a battery shell, a partition, electrolyte, positive and negative plates; a partition is installed between the upper and lower adjacent positive and negative plates in the same plate group, a gap is provided on the partition wall along the stacking direction of the positive and negative plates to connect the cells on both sides, the sides of the positive plate and the negative plate are respectively provided with positive lug and negative lug, and the positive electrode plate and the negative electrode plate installed opposite to each other between the two adjacent plate groups form a horizontal plate by connecting their lugs together.

CN103208633A also discloses a horizontal battery and its manufacturing method, which comprises a battery shell and an upper cover, the battery shell is provided with a number of battery plate groups and separators that block the flow of electrolyte between plate groups, both ends of the shell are provided with lead-out terminals connected to the plate group, the plate group comprises positive and negative plates that are alternately stacked, and a porous partition is arranged between the positive plate and the negative plate.

In the traditional maintenance-free (lean solution) AGM lead battery, the internal plate group is always in a compressed state throughout the life cycle, only in this state the electrolyte forms a film effect at the compressed micropores and the oxygen recombination reaction occurs inside the battery, so the gas can be transported in an incompletely saturated liquid absorption state, and effective pressure can inhibit the growth of lead dendrite and prevent lead paste falling off and migration of harmful impurity ions; if the compression state is invalid, unbalanced, or the pressure is too small, it will cause the battery capacity to decay too fast, and the battery cycle performance is too poor.

The electrode plates of the horizontal lead-acid battery disclosed in the above documents are placed horizontally, the bottom surface of the plate group is close to the bottom of the container and the top surface is suspended, the plate group and the container are no longer tightly matched, resulting in a decrease in battery performance. Moreover, the sealing performance is poor or the structure is relatively complicated.

### SUMMARY OF THE INVENTION

The present invention provides a horizontal lead-acid battery, which solves the problem of poor sealing performance between adjacent cells, eliminates the plate group lug welding, bridge lead parts, welding or cast welding process in the production of traditional lead-acid batteries, avoids the input of materials, equipment and manpower in the traditional battery production process, reduces manufacturing energy consumption, and prevents process pollution, thereby effectively reducing production costs and making the production mode greener and more efficient.

A horizontal lead storage battery, comprising a battery container and a cover, the interior of said battery container is installed with a partition that divides its inner cavity into a plurality of cells, each cell is installed with a horizontal plate group, and adjacent plate groups are connected by a bridge, said partition has a gap for the bridge to pass through, and a sealing component is installed at the gap, characterized in that, said sealing component comprises two sealing plates with a gap and sealed with said partition; said gap is filled with sealant.

Both sides of said sealing plate are sealed with the inner surface of said gap.

Both inner sides of said gap are installed with chutes that cooperate with the edges of the sealing plate.

Said sealing plate is spliced by two halves, and has a through hole for the bridge to pass through. The surface of said sealing plate can be waxed, which reduces the resistance to enter the chute and increases the effectiveness of the snap-fit seal of the sealing plate.

Said plate group is installed with a pressure plate in the top to clamp with the inner wall of the single cell and press said plate group.

Said single cell is installed with a catching groove inside, and the edge of said pressure plate is installed with an elastic buckle that cooperates with the catching groove.

The upper surface of said pressure plate is installed with reinforcing ribs.

Said pressure plate is installed with vent holes.

Said plate group includes positive and negative plates that are alternately stacked, and the positive and negative plates of adjacent plate groups are connected by a bridge to form a bipolar plate.

Said bipolar plate is formed by stamping.

The grid of said bipolar plate is a mesh structure, and the mesh is a regular hexagon.

Said cover is installed with filling port columns corresponding to the single cells one by one and a cover plate for covering said filling port columns.

The upper surface of said cover is installed with a cover plate groove fitting with the cover plate, and said filling port columns are provided in the cover plate groove.

The circumference of said filling port column is recessed downward.

The top of said sealing plate is flush with the partition or slightly higher than said partition.

The gap of the partition of present invention is installed with two sealing plates, the space between the two sealing plates is filled with sealant, and the tiny space between the sealing plate and the partition is blocked by sealing, thereby improving the sealing effect.

### DESCRIPTION OF FIGURES

FIG. 1 is a schematic diagram of the structure of the horizontal lead storage battery of the present invention.

FIG. 2 is a cross-sectional view of the horizontal lead storage battery of the present invention.

FIG. 3 is a schematic diagram of the structure of the battery container.

FIG. 4 is a schematic diagram of the structure of the cover.

FIG. 5 is a schematic diagram of the structure of the grid.

FIG. 6 is a schematic diagram of the structure of the sealing plate.

FIG. 7 is a transverse cross-sectional view of the gap of the partition.

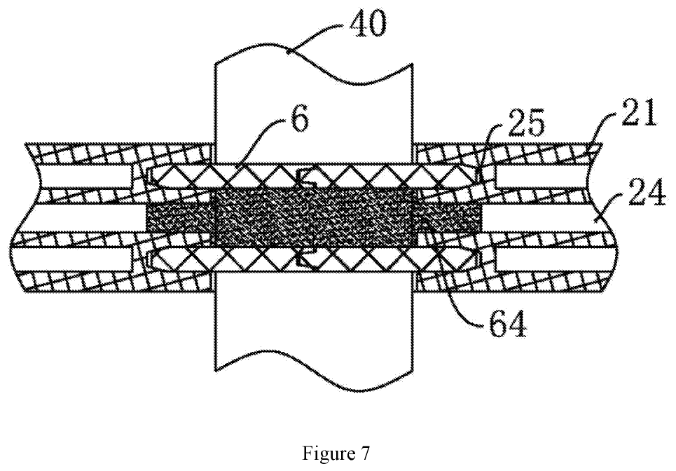

FIG. 8 is a longitudinal cross-sectional view of the gap of the partition.

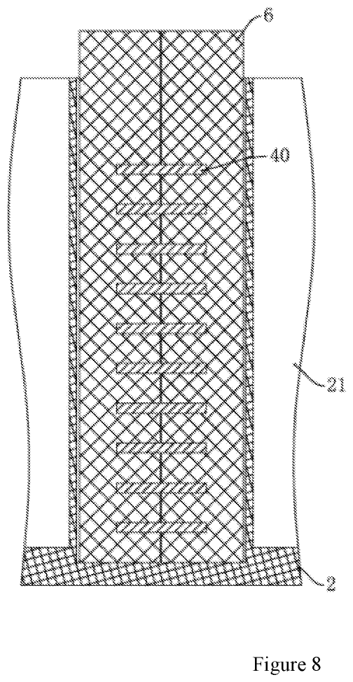

FIG. 9 is a schematic diagram of the structure of the pressure plate.

FIG. 10 is a schematic diagram of the matching structure of the pressure plate and the battery container.

### MODE OF CARRYING OUT THE INVENTION

The technical solutions in the embodiments of the present invention will be clearly and completely described below in combination with the accompanying figures in the embodiments of the present invention. Evidently, the described embodiments are only a part, rather than all the embodiments of the present invention. Based on the embodiments of the present invention, all other embodiments obtained by those of ordinary skill in the art without creative work shall fall within the protection scope of the present invention.

It should be noted that when a component is said to be “connected” with another component, it can be directly connected to the other component or there may also be a central component. When a component is considered to be “installed on” another component, it can be directly installed on another component or there may be a centered component.

Unless otherwise defined, all technical and scientific terms used herein have the same meaning as commonly understood by those skilled in the technical field of the present invention. The terminology used in the description of the present invention herein is only for the purpose of describing specific embodiments, and is not intended to limit the present invention. The term “and/or” as used in this article includes any and all combinations of one or several related listed items.

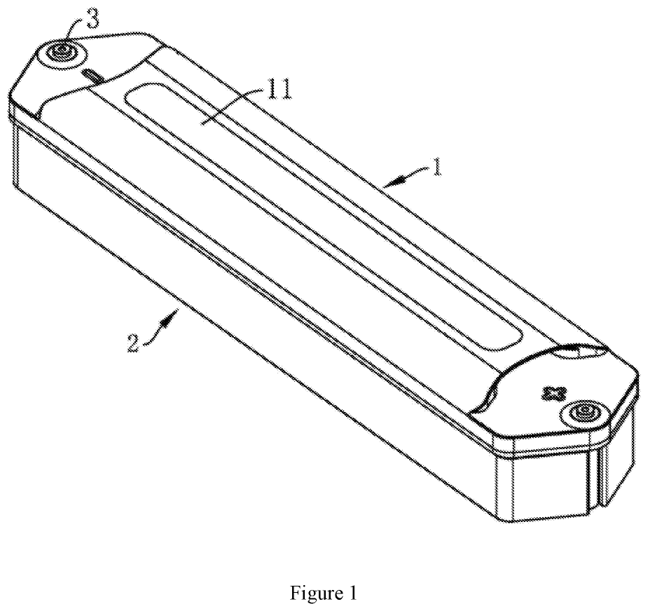

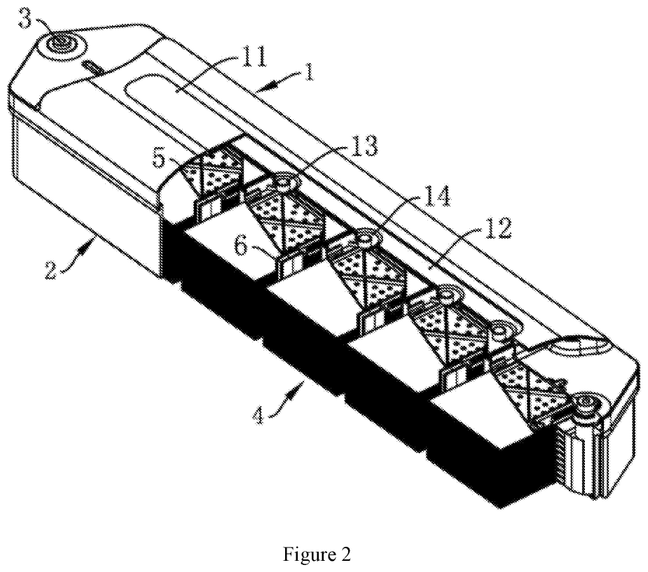

As shown in FIG. 1-2, a horizontal lead storage battery, comprising a battery container 2 and a cover 1; the battery container 2 is installed with six horizontally arranged plate groups 4, and both ends of the cover 1 are installed with connection terminals 3.

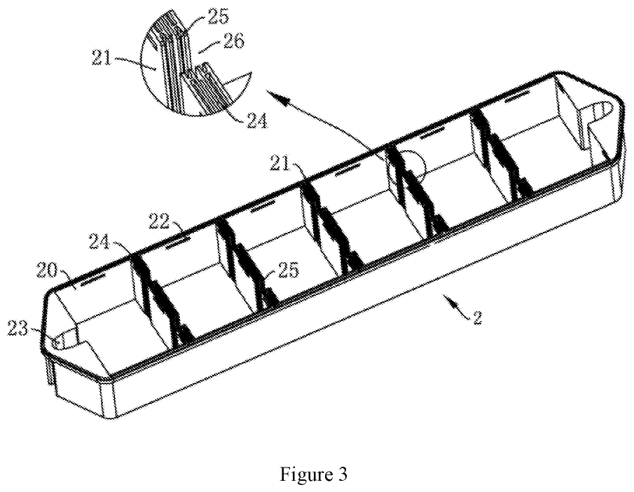

As shown in FIG. 3, the battery container 2 has a hollow structure, a plurality of partitions 21 dividing its inner cavity into six cells 20 are installed inside, and the inside of cover 1 is also installed with partition. The opening edge of the battery container 2 and the top edge of the partition are installed with a slot 24, the edge of the slot and the bottom edge of the partition are inserted into the slot 24, and engage to form a sealed structure. The slot 24 is generally filled with sealant, so that the two are permanently connected. Both ends of the battery container 2 are also installed with grooves 23 for placing the terminal poles, which are connected with the single cells 20 at both ends.

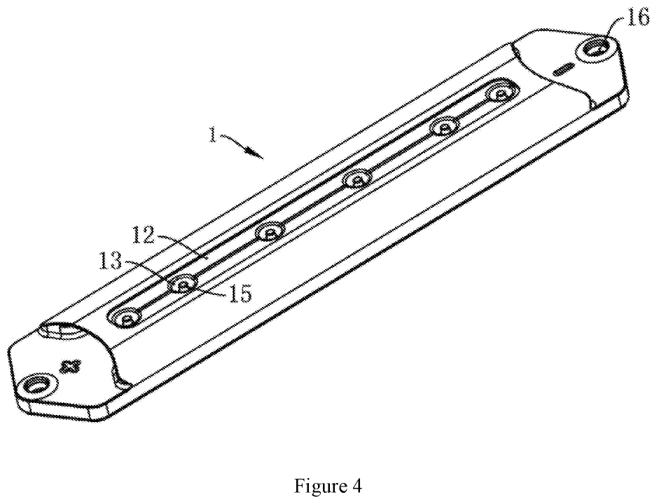

As shown in FIG. 4, the top surface of the cover 1 is installed with a cover plate groove 12 and a matching cover plate 11, the bottom surface of the cover plate groove 12 is installed with a filling port column 15, the top of the filling port column 15 is installed with a valve cap 14, a funnel-shaped depression 13 is installed around the filling port column 15, and adjacent depression 13 is connected through an exhaust groove.

Each plate group 4 consists of a positive plate, a negative plate, and a partition between the two; the number of positive and negative plates can be adjusted according to the battery capacity; the partition can be wrapped in a single plate or double plates; the so-called single plate wrapping refers to only the positive plate, and the double plate wrapping only refers to wrapping both types of polar plates.

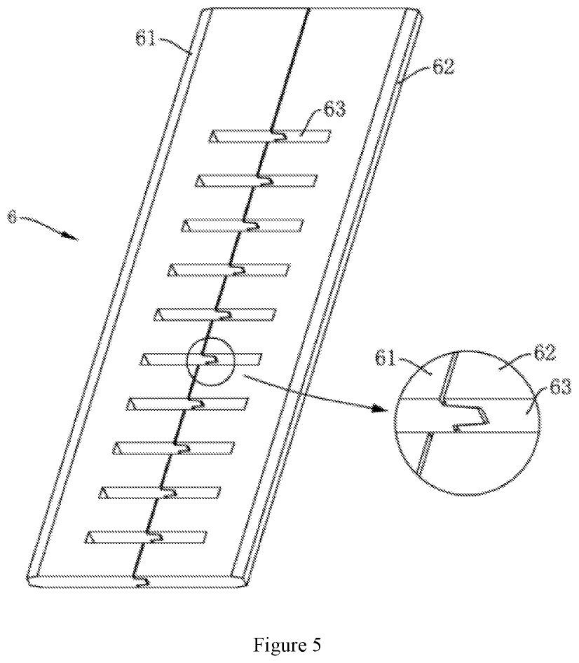

In order to avoid problems caused by uneven reactions across the polar plates due to electrolyte stratification, the horizontal battery plates of the present invention are placed horizontally. As shown in FIG. 5, the positive and negative plates of adjacent plate groups are connected through bridge 40 to form a bipolar plate. If the positive plate of a plate group is connected to the negative plate of the left plate group, the negative plate is connected to the positive plate of the right plate group and there is no plate group on the left or right, it is connected to the terminal pole.

As shown in 2, 7 and 8, the partition 21 has a gap 26 for the bridge 40 to pass through, the gap 26 is installed with two opposite sealing plates 6, the inner side of the gap 26 is installed with a chute 25, and both sides of the sealing plate 6 are snapped into the chute 25 to form a sealed fit, which is also convenient for installation. Since there is inevitably a space between the sealing plate and the partition, the space between the two sealing plates 6 communicates with the embedding groove 24, and the inside is filled with sealant 64.

In order to facilitate installation, the sealing plate 6 is composed of left and right halves, the left half 61 has a slot and the right half 62 has a convex edge, and the convex edge is inserted into the slot to form a sealed fit. The sealing plate 6 also has a number of through holes 23 for the bridge 40 to pass through. In order to avoid leakage of glue, bayonets 43 for matching the left half 61 and the right half 62 are installed on both sides of the bridge 40.

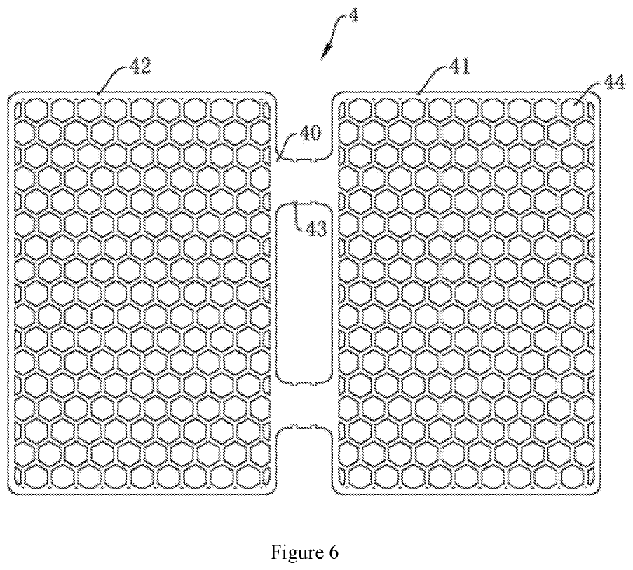

As shown in FIG. 6, except for the plate groups on the side, the plates of other plate groups are all bipolar structures, that is, they include a positive plate 41 and a negative plate 42, the positive and negative plates are located on two adjacent plate groups 4, and a bridge 40 connecting them is installed in the middle. The grid of the bipolar plate of the present invention is formed by stamping and has a mesh structure, and the mesh shape is a regular hexagon, which receives uniform force and can avoid the grid from being deformed.

The bipolar plate of the present invention can adopt the process of continuous casting, continuous rolling, continuous punching, and continuous drawing. The production process of the plate is basically free of lead smoke and lead dust emission, and is environmentally friendly, energy-saving, clean and efficient.

In some of the embodiments, the bipolar plate is integrally formed, and there are two bridges between the positive plate and the negative plate, which replaces the traditional way of connecting adjacent plate groups by welding busbars and bridges, reduces the manufacturing energy consumption and prevents process pollution.

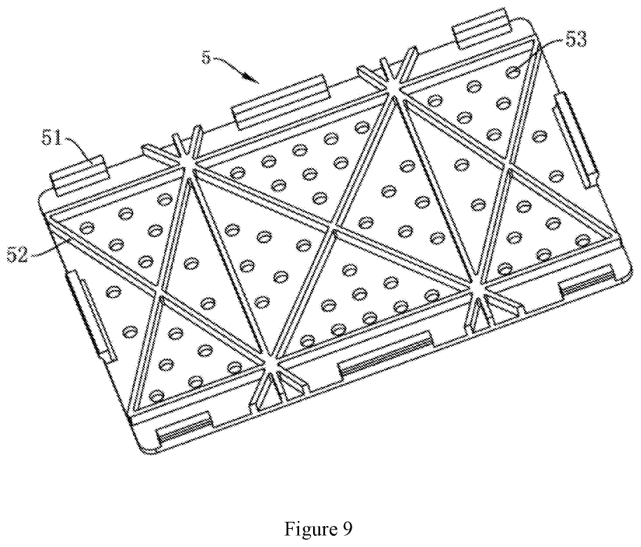

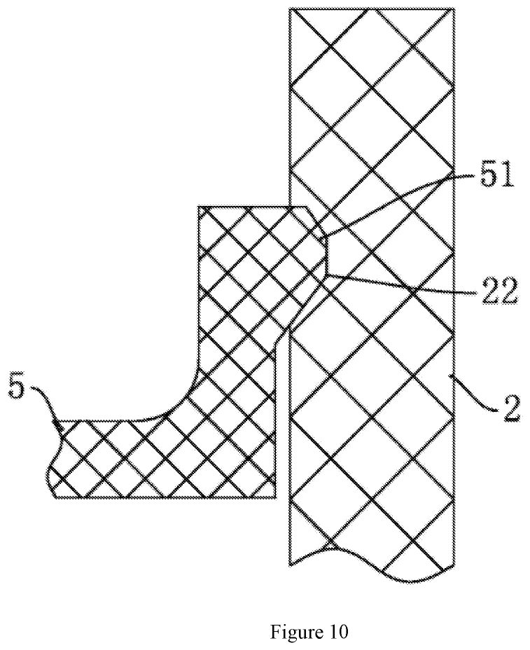

As shown in FIG. 2, in order to allow the plate groups to have a certain assembly pressure, a pressure plate 5 is installed above each plate group 4. As shown in FIG. 9, the shape of the pressure plate 5 is adapted to the shape of the single cell, and the side surface of the pressure plate 5 facing away from the plate group 4 is installed with reinforcing rib 52 to increase its strength. In order to facilitate exhaust and liquid injection, the pressure plate 5 is also installed with many vent holes 53. The edge of the pressure plate 5 is installed with a plurality of elastic buckles 51. As shown in FIG. 10, the elastic buckle 51 cooperates with the catching groove 22 on the inner wall of the single cell 20 to achieve fixation and facilitate assembly.

The end poles are welded to the plate groups 4 on both sides, and the heads pass through the cover 1 to form a connection terminal 3.

The technical features of the above-mentioned embodiments can be combined arbitrarily. In order to make the description concise, all possible combinations of the technical features in the above-mentioned embodiments are not described. However, as long as there is no contradiction in the combination of these technical features, all should be considered as the scope of this specification. When the technical features of different embodiments are reflected in the same figure, it can be regarded that the figure also discloses the combination examples of the various embodiments involved.

The above-mentioned embodiments only describe several implementation modes of the present invention, the description is relatively specific and detailed, but it should not be understood as a limitation on the scope of the invention patent. It should be pointed out that for those of ordinary skill in the art, several modifications and improvements can be made within the scope of the inventive concept, and these are all in the protection scope of the present invention. Therefore, the protection scope of the present invention should be subject to the appended claims.

We claim:

1. A horizontal lead storage battery, comprising a battery container and a cover, the interior of said battery container is provided with a partition that divides its inner cavity into a plurality of cells, and each cell is provided with a horizontal plate group; adjacent plate groups are connected by a bridge; said partition has a gap for the bridge to pass through, and a sealing component is arranged at the gap, characterized in that, said sealing component comprises two sealing plates with a gap and sealed with said partition, and said gap is filled with sealant.

2. The horizontal lead storage battery of claim 1, characterized in that, the two sides of said sealing plate are sealed with the inner surface of said gap.

3. The horizontal lead storage battery of claim 2, both inner sides of said gap are installed with chutes that cooperate with the edges of the sealing plate.

4. The horizontal lead storage battery of claim 1, characterized in that, said sealing plate is spliced by two halves.

5. The horizontal lead storage battery of claim 1, characterized in that, a pressure plate is installed above said plate group to engage with the inner wall of the single cell and press said plate group.

6. The horizontal lead storage battery of claim 5, characterized in that, a catching groove is installed inside said single cell, and the edge of said pressure plate is installed with an elastic buckle that cooperates with the catching groove.

7. The horizontal lead storage battery of claim 5, characterized in that, the upper surface of said pressure plate is installed with reinforcing ribs.

8. The horizontal lead storage battery of claim 5, characterized in that, said pressure plate is installed with vent holes.

9. The horizontal lead storage battery of claim 1, characterized in that, said plate group includes positive and negative plates that are alternately stacked, and the positive and negative plates of adjacent plate groups are connected by a bridge to form a bipolar plate.

10. The horizontal lead storage battery of claim 9, characterized in that, said bipolar plate is formed by stamping.

11. The horizontal lead storage battery of claim 9, characterized in that, the grid of said bipolar plate is a mesh structure, and the mesh is a regular hexagon.

12. The horizontal lead storage battery of claim 1, characterized in that, said cover is installed with filling port columns corresponding to the single cells one by one and a cover plate for covering said filling port columns.

13. The horizontal lead storage battery of claim 12, characterized in that, the upper surface of said cover is installed with a cover plate groove fitting with the cover plate, and said filling port columns are provided in the cover plate groove.

14. The horizontal lead storage battery of claim 12, characterized in that, the circumference of said filling port column is recessed downward.

15. The horizontal lead storage battery of claim 1, characterized in that, the top of said sealing plate is flush with the partition or slightly higher than said partition.
